(19) United States
(12) Patent Application Publication
(10) Pub. No.: US 2010/0238652 A1
(43) Pub. Date: Sep. 23, 2010

(54) FLASHLIGHT ASSEMBLY

(76) Inventors: Su-Chang Liao, Taichung City (TW); Di-Shun Liao, Taichung City (TW)

Correspondence Address: Yen Jung Sung, 21-80 38 St, #C8, Astoria, NY, 11105, US

(21) Appl. No.: 12/408,690

(22) Filed: Mar. 21, 2009

(51) Int. Cl. F21L 4/00

(52) U.S. Cl. 362/157

(57) ABSTRACT

A flashlight assembly includes a head portion having a receiving space, a light assembly received in the receiving space, and a radiator. The radiator is received in the receiving space and abuts against the light assembly. The radiator has an inner surface and an outer surface both defined therein. The inner surface has a protrusion extended therefrom. The protrusion abuts against the light assembly. Heat generated by the light assembly is conducted to the radiator via the protrusion and dissipated from the outer surface.

### BACKGROUND OF THE INVENTION

1. Field of the Invention

The present invention relates to a flashlight, and more particularly to a flashlight assembly having a heat dissipation structure.

2. Description of Related Art

A conventional flashlight in accordance with the prior art comprises a handle portion, a battery set, a lamp unit, and a head portion. The handle portion and the head portion of the conventional flashlight are made of plastic. After a period of usage, the lamp unit causes a great heat, especially if the lamp unit is light emitting diode (LED) lamp. If this heat is not effectively dissipated, it may cause damage to the lamp unit. The plastic handle portion and head portion are also fractured by the heat.

The present invention has arisen to mitigate and/or obviate the disadvantages of the conventional flashlight.

### SUMMARY OF THE INVENTION

The main objective of the present invention is to provide an improved flashlight assembly, in that a flashlight assembly which has a heat dissipation structure is acquired.

To achieve the objective, the flashlight assembly includes a head portion having a receiving space, a light assembly received in the receiving space, and a radiator. The radiator is received in the receiving space and abuts against the light assembly. The radiator has an inner surface and an outer surface both defined therein. The inner surface has a protrusion extended therefrom. The protrusion abuts against the light assembly. Heat generated by the light assembly is conducted to the radiator via the protrusion and dissipated from the outer surface.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a flashlight assembly in accordance with the present invention;

FIG. 2 is an assembled perspective view of the flashlight assembly in accordance with the present invention in FIG. 1;

FIG. 3 is a side plane cross-sectional view of the flashlight assembly in accordance with the present invention;

FIG. 4 is a front elevation cross-sectional view of the flashlight assembly in accordance with the present invention, showing the inner housing, the radiator, and the outer housing;

FIG. 5 is a perspective view of the radiator of the flashlight assembly in accordance with the present invention;

FIG. 6 is another perspective view of the radiator of the flashlight assembly in accordance with the present invention;

FIG. 7 is front elevation view of the radiator of the flashlight assembly in accordance with the present invention in FIG. 5;

FIG. 8 is a cross-sectional view of the radiator of the flashlight assembly in accordance with the present invention taken along line 8-8 in FIG. 7; and

FIG. 9 shows that the flashlight assembly in accordance with the present invention is connected to a bicycle handlebar.

### DETAILED DESCRIPTION OF THE INVENTION

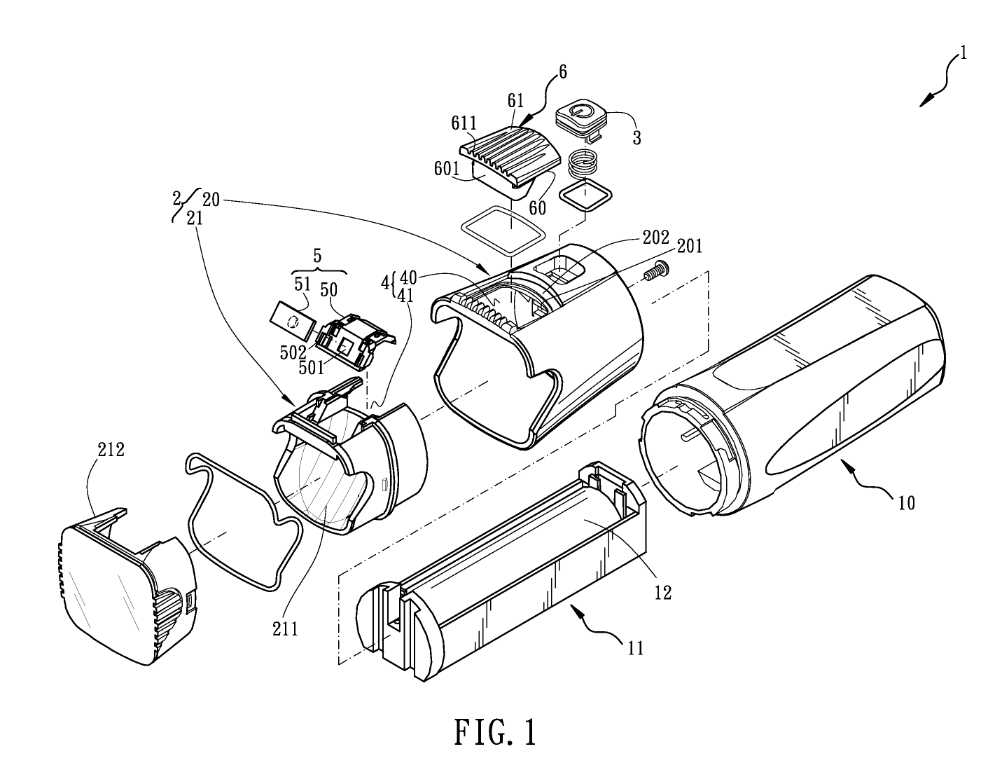

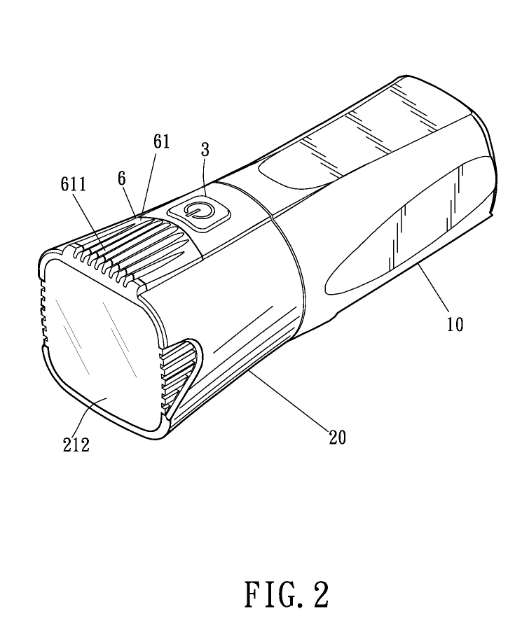

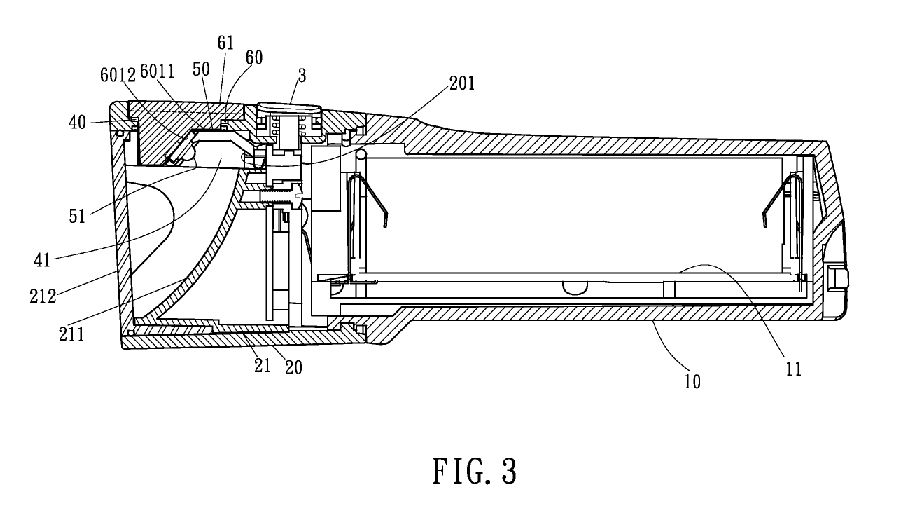

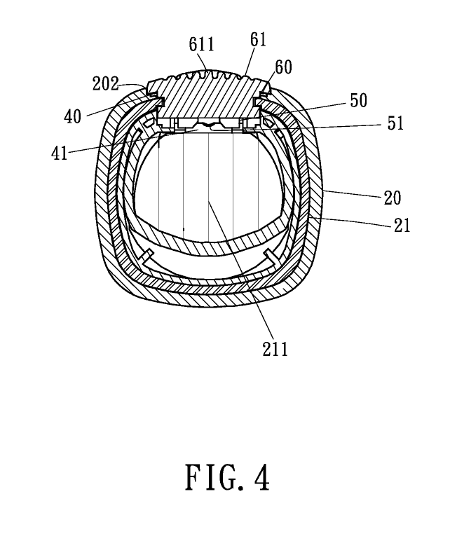

Referring to the drawings and initially to FIGS. 1-4, a flashlight assembly 1 in accordance with the present invention comprises a head portion 2 and a handle 10 connected to the head portion 2. The head portion 2 and the handle 10 are made of plastic. The handle 10 is provided to be adapted to a bicycle or hold by hand. The handle 10 includes a battery set 11 received in the handle 10 and a battery 12 received in the battery set 11. The flashlight assembly 1 in accordance with the present invention further comprises a button 3 received in the head portion 2 for switching on/off the flashlight assembly 1.

The head portion 2 has a receiving space 4 defined in a lateral thereof. The flashlight assembly 1 in accordance with the present invention further comprises a light assembly 5 and a radiator 6 both received in the receiving space 4. The head portion 2 includes an outer housing 20 and an inner housing 21 received in the outer housing 20. The outer housing 20 has a first receiving space 40 defined in a lateral thereof for receiving the radiator 6. The inner housing has a second receiving space 41 defined in a lateral thereof and corresponding to the first receiving space 40 for receiving the light assembly 5. The outer housing 20 has an engaging groove 201 defined therein and a shoulder 202 extended from a side wall (not numbered) of the first receiving space 40. The inner housing 21 has a reflecting portion 211 formed therein. The reflecting portion 211 has a concave cambered surface for reflecting the light from the light assembly 5. The flashlight assembly 1 in accordance with the present invention further comprises a transparent cover 212 connected to the head portion 2.

The light assembly 5 includes a base 50 and an illuminator 51. The illuminator 51 is a LED lamp. The base 50 is in a shape of arch. The base 50 has a through hole 501 defined in one end thereof and two projections 502 extended therefrom. The other end of the base 50 is engaged with the engaging groove 201. The illuminator 51 passes the through hole 501. The light from the illuminator 51 is reflected by the reflecting portion 211 and passes through the transparent cover 212. The illuminator 51 is connected to the radiator 6.

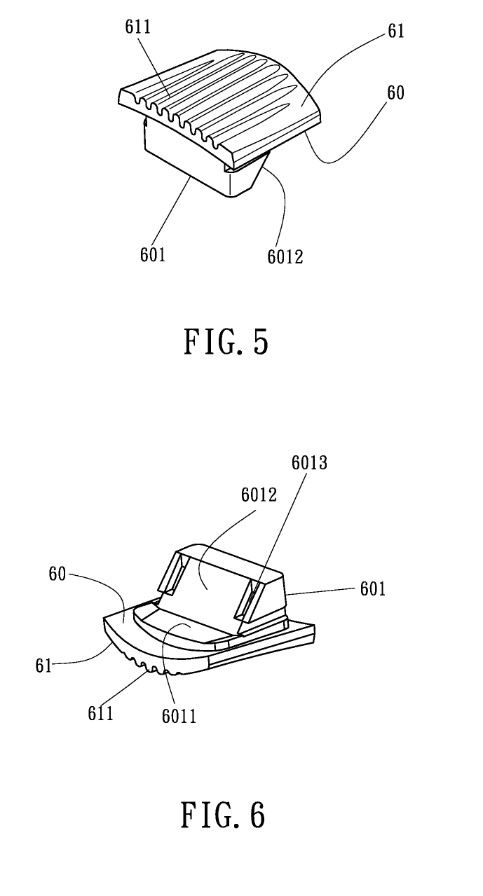

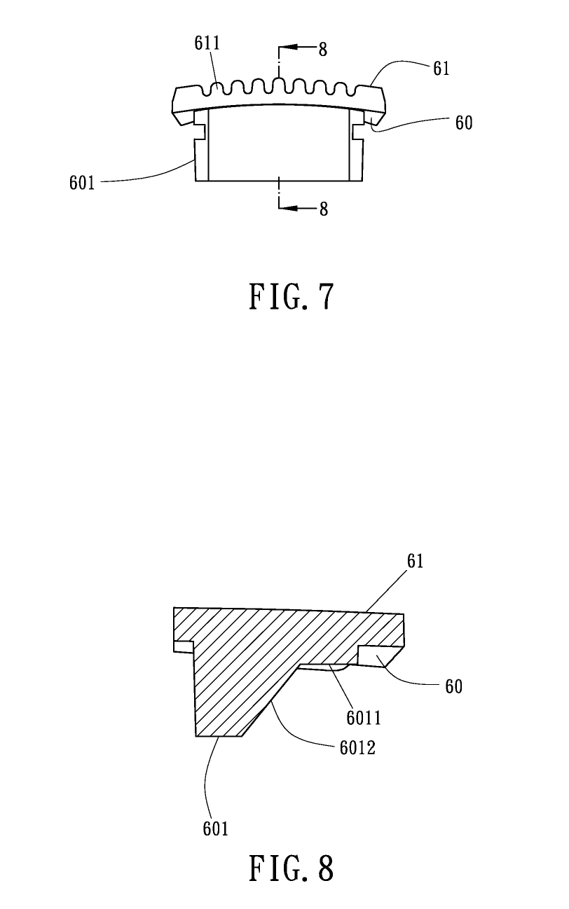

Referring to FIGS. 5-8, the radiator 6 has an outer surface 61 and an inner surface 60. The radiator 6 is made of metal, i.e. aluminum. The outer surface 61 contacts with the air for convecting the heat from the illuminator 51. The outer surface 61 has multiple radiation ribs 611 extended therefrom to increase the effort of heat dissipation. The inner surface 60 abuts against the shoulder 202. The inner surface 60 has a protrusion 601 extended therefrom. The protrusion 601 extends into the first receiving space 40 and the second receiving space 41 and abuts against the light assembly 5. The protrusion 601 has a resisting surface 6011 and an incline surface 6012 both defined therein. The resisting surface abuts against the base 50. The inclined surface 6012 abuts against the illuminator 51. The inclined surface 6012 is provided to increase the contacting area between the radiator 6 and the illuminator 51 to increase the effort of heat conduction. The inclined surface 6012 has two recesses 6013 defined therein and corresponding to the two projections 502 of the base 50. Each projection 502 engages with the corresponding recess 6013 to fasten the base 50 with the radiator 6.

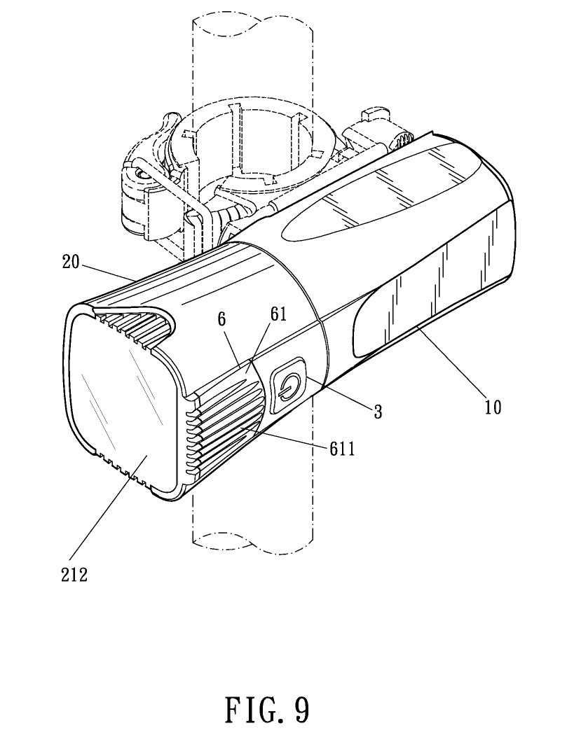

Referring to FIG. 9, the flashlight assembly 1 in accordance with the present invention is connected to a bicycle handlebar (not numbered). The heat generated by the illuminator 51 is conducted to the protrusion 601 via the inclined surface 6012. The heat is dissipated by the radiation and convection of the radiator 6.

Although the invention has been explained in relation to its preferred embodiment, it is to be understood that many other possible modifications and variations can be made without departing from the spirit and scope of the invention as hereinafter claimed.

What is claimed is:

1. A flashlight assembly comprising:
a head portion having a receiving space;
a light assembly received in the receiving space; and
a radiator received in the receiving space and abutted against the light assembly, the radiator having an inner surface and an outer surface both defined therein, the inner surface having a protrusion extended therefrom, the protrusion abutted against the light assembly;
wherein heat generated by the light assembly is conducted to the radiator via the protrusion and dissipated from the outer surface.

2. The flashlight assembly as claimed in claim 1, wherein the protrusion has a resisting surface and an inclined surface both defined therein.

3. The flashlight assembly as claimed in claim 2, wherein the light assembly includes a base and an illuminator, the base abutted against the resisting surface, the illuminator abutted against the inclined surface.

4. The flashlight assembly as claimed in claim 1, wherein the outer surface has multiple radiation ribs.

5. The flashlight assembly as claimed in claim 1, wherein the head portion includes an outer housing and an inner housing received in the outer housing, the outer housing having a first receiving space defined therein for receiving the radiator, the inner housing having a second receiving space defined therein for receiving the light assembly, the second receiving space communicated with the first receiving space.

6. The flashlight assembly as claimed in claim 1, wherein the light assembly includes a base and an illuminator, the base having a through hole defined therein, wherein one end of the illuminator is passed through the through hole and the other end of the illuminator is abutted against the protrusion.

7. The flashlight assembly as claimed in claim 6, wherein the base has two projections extended therefrom; the protrusion has two recesses defined therein and corresponding to the two projections for engaging the two projections.

8. The flashlight assembly as claimed in claim 1, wherein the head portion is made of plastic.

9. The flashlight assembly as claimed in claim 1, wherein the radiator is made of metal.
